(19) United States
(12) Patent Application Publication
(10) Pub. No.: US 2025/0293950 A1
(43) Pub. Date: Sep. 18, 2025

(54) DATA TRANSMISSION METHOD, ELECTRONIC APPLIANCE ARCHITECTURE OF VEHICLE-MOUNTED ETHERNET, AND ELECTRONIC DEVICE

(71) Applicants: Futaijing Precision Electronics (Yantai) Co., Ltd., Yantai (CN); HON HAI PRECISION INDUSTRY CO., LTD., New Taipei (TW)

(72) Inventors: JIAN-KAI ZHANG, New Taipei (TW); YI-PENG LIAO, New Taipei (TW); CHAO-CHIEH CHENG, New Taipei (TW)

(21) Appl. No.: 18/752,834

(22) Filed: Jun. 25, 2024

(30) Foreign Application Priority Data
Mar. 12, 2024 (TW) 202410281060.9

(51) Int. Cl. H04L 41/40; H04L 12/40; H04L 49/351; H04L 67/12

(52) U.S. Cl. CPC H04L 41/40; H04L 12/40; H04L 49/351; H04L 67/12; H04L 2012/40273

(57) ABSTRACT

A data transmission method applied to a vehicle. The data transmission method includes obtaining performance information of a link between adjacent switches in the electronic appliance architecture of the vehicle-mounted Ethernet, determining a weight of the link between the adjacent switches, based on the performance information of the link, obtaining objective addresses of data packets, determining objective paths of the data packets transmitted from an objective switch to the objective address, based on the weight of the link between the adjacent switches, generating flow entries based on the objective paths. The flow entries indicating the data packets are transmitted on the objective paths and sending the flow entries to the objective switch. An electronic appliance architecture of the vehicle-mounted Ethernet and an electronic device are also disclosed.

### FIELD

The subject matter herein generally relates to vehicle technology field.

### BACKGROUND

An Electrical/Electronic Architecture (EEA) of a vehicle can integrate various sensors, Electronic Control units (ECU), harness topology and an electrical and electronic distribution system to complete data calculation, power and energy distribution, and various functions of the vehicle is completed.

As vehicle functions become more complex and a number of the vehicle sensors increases, the EEA of the vehicle processes and transmits more and more data.

How to ensure transmission efficiency of a large amount of data in the vehicle is an urgent problem to be solved.

### BRIEF DESCRIPTION OF THE DRAWINGS

Implementations of the present disclosure will now be described, by way of embodiments, with reference to the attached figures.

FIG. 1 is a diagram illustrating an embodiment of a vehicle according to of the present disclosure.

FIG. 2 is a diagram illustrating an embodiment of an electronic appliance architecture of a Vehicle-mounted Ethernet according to of the present disclosure.

FIG. 3 is an interaction scene diagram illustrating an embodiment of a Software Defined Network (SDN) controller and a switch according to of the present disclosure.

FIG. 4 is a flowchart of an embodiment illustrating a data transmission method according to the present disclosure.

FIG. 5 is a diagram of network topology illustrating an embodiment of the electronic appliance architecture of the Vehicle-mounted Ethernet according to the present disclosure.

FIG. 6 is a diagram of an embodiment illustrating an electronic device.

### DETAILED DESCRIPTION

It will be appreciated that for simplicity and clarity of illustration, where

appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to;” it specifically indicates open-ended inclusion or membership in the so-described combination, group, series, and the like.

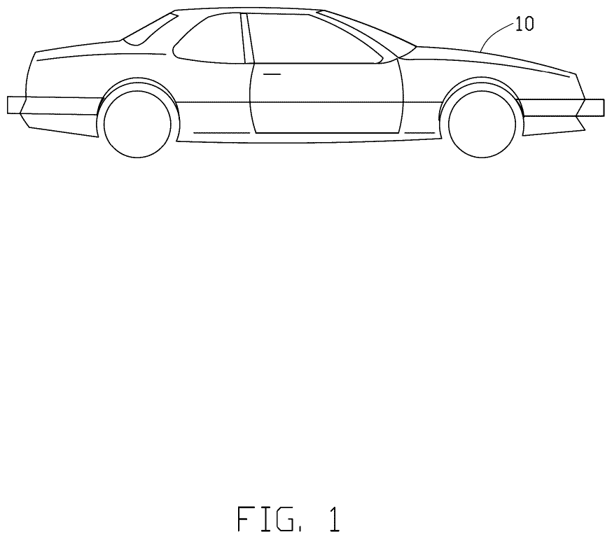

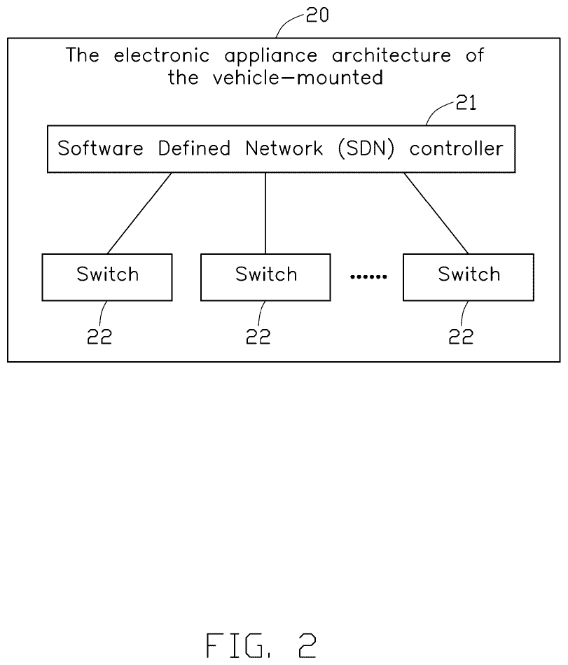

Please refer to FIG. 1, FIG. 1 illustrates one exemplary embodiment of a vehicle 10. The vehicle 10 is configured with an electronic appliance architecture of a vehicle-mounted Ethernet 20 as shown in FIG. 2.

The electronic appliance architecture of the vehicle-mounted 20 includes a plurality of nodes. The plurality of nodes includes a plurality of switches 22. The plurality of switches 22 is devices with data forwarding function.

In some embodiments, the plurality of nodes also includes vehicle equipments, the vehicle equipments can be displays, vehicle-sensors, Electronic Control units (ECUs) meters, etc. The device type of the plurality of nodes and network topology of the plurality of nodes can also be set, according to practical application requirements, such as functions of the vehicle 10 and data transmission requirements within the vehicle 10.

In one embodiment, the electronic appliance architecture of the vehicle-mounted 20 can adopt a centralized architecture.

The centralized architecture implements unified management and scheduling for the internal resources of the vehicle 10, large-scale information processing and efficient energy management can be achieved to improve overall performance of a vehicle system. The vehicle 10 adopts cloud computing technology and big data technology for data processing to provide convenience for functional expansion, technological progress and market demand changes are met.

In some embodiments, the electronic appliance architecture of the vehicle-mounted 20 can adopt the SDN. The SDN can separate a control plane from a data plane to achieve flexible control of network traffic, and a network of the vehicle 10 is more intelligent.

Please refer to FIG. 2, the electronic appliance architecture of the vehicle-mounted 20 also includes a SDN controller 21. The SDN controller 21 can adopt OpenFlow protocol. In other embodiments, the SDN controller 21 can adopt other protocols.

The SDN controller 21 is configured to one or more electronic devices. The SDN controller 21 communicates with the plurality of switches 22. The SDN controller 21 is configured to send flow entries to the plurality of switches 22, the flow entries indicate transmission paths of data packets.

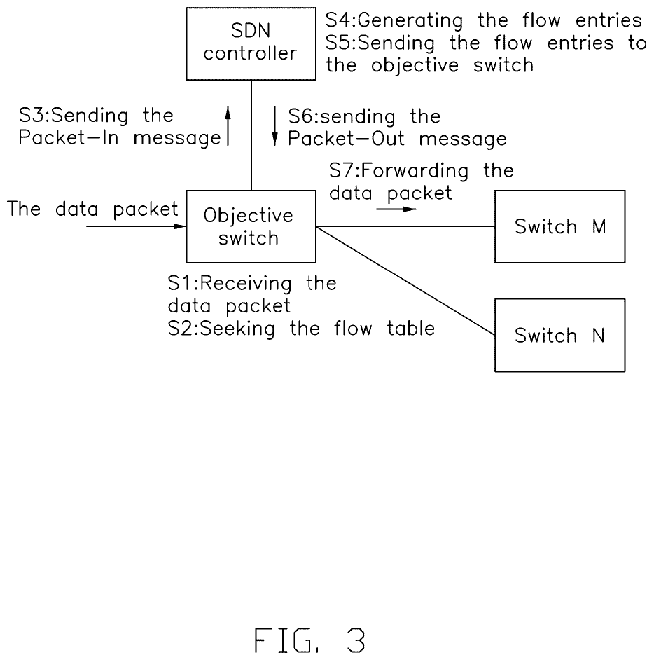

Please refer to FIG. 3, in the electronic appliance architecture of the vehicle-mounted 20, interaction of the SDN controller 21 with an objective switch of the plurality of switches 22 includes some blocks.

In block S1, the objective switch receives the data packet.

The objective switch is a switch where the data packet to be forwarded resides.

In block S2, the objective switch seeks a flow table.

The objective switch is configured with the flow table, the flow table includes several flow entries. Each flow entry includes match fields and instructions.

When the objective switch receives the data packet, the objective switch matches a header of the data packet with the match fields of each flow entry to generate a match result. If the match result is successful, the objective switch can execute the instructions of the flow entries, for example, the data packet is forwarded to next node in the flow entries. If the match result is unsuccessful, no matching flow entries exist in the flow table, the objective switch can perform block S3.

In block S3, the objective switch sends a Packet-In message to the SDN controller.

The data packet is carried in the Packet-In message.

In block S4, the SDN controller generates the flow entries.

After the SDN controller 21 has been received the Packet-In message, the flow entries can be generated based on the data packet. For example, the SDN controller 21 can perform some blocks from block 401 to block 405 to generate the flow entries. The blocks from block 401 to block 405 are described in below.

After the SDN controller 21 generates the flow entries, the block S5 can be performed.

In block S5, the SDN controller sends the flow entries to the objective switch.

For example, the SDN controller can use FlowMod message to carry the flow entries, the FlowMod message is sent to the objective switch, and the objective switch receives the FlowMod message to install the flow entries.

In block S6, the SDN controller sends a Packet-Out message to the objective switch.

In one embodiment, block S7 will be performed after the objective switch receives the Packet-Out message.

In block S7, the objective switch forwards the data packet.

After the objective switch receives the Packet-Out message, the objective switch can forward data according to the instructions of the flow entries. For example, the objective switch is communication with a switch M and a switch N, if the instructions of the flow entries are the data is forwarded to the switch M, the objective switch will forward the data to the switch M.

In some embodiments, the electronic appliance architecture of the vehicle-mounted 20 adopts a Time-Sensitive Software-Defined Network (TSSDN). The electronic appliance architecture of the vehicle-mounted 20 can combine a Software-Defined Network (SDN) and a Time-Sensitive Networking (TSN).

The TSN implements a deterministic minimum time delay protocol family in nondeterministic Ethernet and defines the time-sensitive mechanism of Ethernet data transmission. Certainty and reliability of standard Ethernet is increased to ensure that the data is transmitted in real time.

In some embodiments, the objective switch can also adopt a time-sensitive protocol, and the objective switch is also used to obtain types of a data packet after the data packet has been received. The types of the data packet include control signals related to driving safety, control signals unrelated to the driving safety, streaming media signals unrelated to the driving safety and sensor data in vehicle 10, etc. Then, transmission priority of the data packet is determined based on the types of the data packet and the time-sensitive protocol, and the data packet is forwarded based on the transmission priority.

The transmission priority can correspond to delay and jitter of the data packet. The users can configure different types of the data packet and the corresponding transmission priorities based on the time-sensitive protocol.

For example, the control signals related to the driving safety correspond to highest transmission priority, and the data packet corresponding to the highest transmission priority has lower delay and less jitter. The streaming media signals unrelated to the driving safety can correspond to lower transmission priority, and the data packet corresponding to the lower transmission priority has higher delay and jitter.

Low latency and deterministic data transmission of the electronic appliance architecture of the vehicle-mounted 20 through the TSN network can be realized, and critical information (such as sensor data and control signals) can be transmitted timely and reliably.

In one embodiment, network administrators or systems can dynamically control network traffic through software applications without the need to manually configure network devices. Dynamic nature makes a network to handle changing network requirements and conditions more effectively, such as different in-vehicle applications may require different network performance and resources.

In other embodiments, the SDN controller 21 can obtain a weight of a link based on performance information of the link, an objective path for transmitting the data packets can be determined. Data transmission performance of the objective path can be ensured, and efficiency of data transmission can be improved.

In one embodiment, the electronic appliance architecture of the vehicle-mounted 20 can adopt the TSSDN. The TSN can ensure the certainty and the low latency of the data transmission, the SDN can provide the dynamic control of the network traffic. The TSSDN enables a vehicle Ethernet to effectively support a variety of different Vehicle applications and meets data transmission requirements of various vehicle applications, the performance and reliability of the various applications can be ensured, and flexibility of vehicle configuration can be improved.

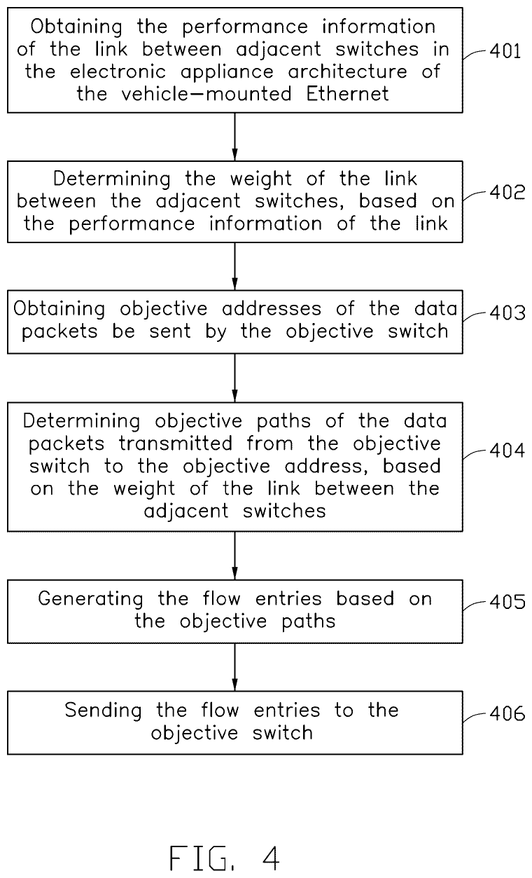

FIG. 4 illustrates one exemplary embodiment of a data transmission method. The flowchart presents an exemplary embodiment of the method. The exemplary method is provided by way of example, as there are a variety of ways to carry out the method. Each block shown in FIG. 4 may represent one or more processes, methods, or subroutines, carried out in the example method. Furthermore, the illustrated order of blocks is illustrative only and the order of the blocks can change. Additional blocks can be added, or fewer blocks may be utilized, without departing from this disclosure.

As shown in FIG. 2, the data transmission method is used for the SDN controller 21. The SDN controller 21 can be configured in the electronic appliance architecture of the vehicle-mounted 20.

In block 401, the performance information of the link between adjacent switches in the electronic appliance architecture of the vehicle-mounted Ethernet is obtained.

In one embodiment, the electronic appliance architecture of the vehicle-mounted 20 includes the plurality of nodes. The plurality of nodes includes the plurality of switches 22. The plurality of switches 22 is devices with data forwarding function.

The adjacent switches are two switches 22 sharing a same link. The link is used for the data transmission between the adjacent switches. In one embodiment, the link can be a physical line, such as a cable or cable, or a path space for transmitting wireless communication signals.

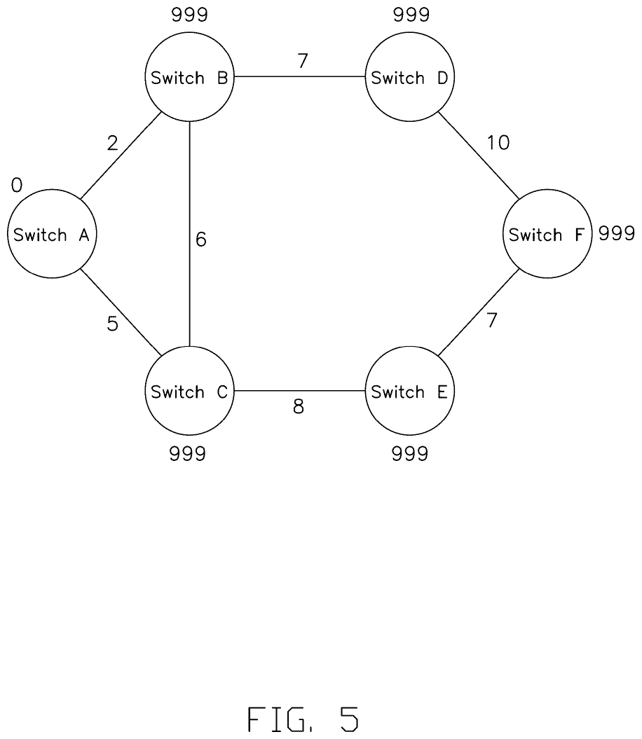

Refer to FIG. 5, switch A and switch B are the adjacent switches, the switch A and switch C are also the adjacent switches.

In one embodiment, a first switch and a second switch are the adjacent switches, a data packet sent from the first switch to the second switch is marked as a first packet, and a data packet sent from the second switch to the first switch is marked as a second packet. When the first switch sends the first packet to the second switch, the performance information of the link between two adjacent switches in block 401 includes the performance of the link for transmitting the first packet.

For example, when the first switch sends the first packet to the second switch, the performance of the link transmitting the first packet includes: a number of the first packet that the first switch had been transmitted to the second switch, a maximum number of the first packet that the link can transmit in a preset period, a number of the first packet that the link can currently transmit to the second packet, a rate that the link transmits the first packet, and whether the link is faulty and so on.

When the second switch sends the second packet to the first switch, the performance information of the link between two adjacent switches in block 401 includes the performance of the link for transmitting the second packet.

In some embodiments, block 401 may further include: obtaining topological information of the electronic appliance architecture of the vehicle-mounted 20 and obtaining the performance information of the links between the adjacent switches, based on the topology information. The SDN controller 21 can adopt OFDP of the OpenFlow to build the topological information of the electronic appliance architecture of the vehicle-mounted 20, the SDN controller 21 can plan routes.

The topological information can describe the plurality of nodes in the electronic appliance architecture of the vehicle-mounted 20 and connection relationships of the plurality of notes. In some embodiments, the SDN controller 21 can also obtain status of each switch 22 in the topology information to control each switch 22, such as running status of the switches 22, bandwidth of the switches 22, and port number of the switches 22 and so on.

In block 402, the weight of the link between the adjacent switches is determined, based on the performance information of the link.

In one embodiment, when one switch sends the data packets to another switch, the SDN controller 21 can determine the weight of the link based on a number of the data packets. The number of the data packets is positively correlated with the weight of the link. For example, the number of the data packets sent from one switch to another switch via the link is the weight of the link.

The flow table includes a counter, the number of the data packets sent from one switch to another switch via the link can be obtained based on counter information of the flow table of the switches. The counter can be maintained by each flow table, each data stream, each device port, and each forward queue in the switches, and the counter is used to collect information of the data packets.

The counter counts a number of currently active table entries, data packets query times, data packets matching times based on each flow table. The counter counts the number of the data packets received, a number of bytes received, duration time of the data stream based on each data stream. The counter counts the number of the data packets received, the number of the data packets sent, the number of the bytes received, the number of the bytes sent, and counts the number of various errors occur based on each switch port. The counter counts the number of the data packets sent, the number of the bytes sent, and a number of overflow errors during sending based on each queue.

In block 403, objective addresses of the data packets be sent by the objective switch are obtained.

In one embodiment, one data packet has one objective address. The objective address indicates an address of an objective device for the data packet be sent. For example, the data packet be sent is camera video data, the objective address is an address of a vehicle display.

In block 404, objective paths of the data packets transmitted from the objective switch to the objective address are determined, based on the weight of the link between the adjacent switches.

In some embodiments, one or more candidate paths exist between the objective switch and the objective address, the candidate path is a path that the data packet can be transmitted from the objective switch to the objective address. Each candidate path is formed by at least one link.

The objective path is a path with a smallest total weight in one or more paths between the objective switch and the objective address, the total weight is a sum weight of the links in one path.

In one embodiment, the objective paths of the data packets are determined based on the weight of the link between the adjacent switches and a Dijkstra algorithm. A shortest distance between the objective switch and other nodes can be calculated, based on the weight of the link between the adjacent switches and the Dijkstra algorithm. The objective paths can be obtained, other nodes refer to nodes in the network topology other than the switch. A shortest distance between the objective switch and one node is a path with a smallest total weight of the links from the switch to the node.

Refer to FIG. 5, the objective switch is the switch A, in the Dijkstra algorithm, in initial value of node weight of other nodes can be configured. The node weight of other nodes can be configured as a larger value, such as the value is “999”, numbers on lines between the adjacent switches indicate the weight of one path.

During a path search process, the node weights of other nodes can be updated to the total weight of the links that the data packet of the objective switch is reached to other nodes. For example, the number of the data packets sent from the switch A to the switch B is 2 based on the counter, and the weight of the link between the switch A and the switch B can be set to 2. If the switch A sends a data packet to the switch B, the total weight of the links which the data packet is passed is 2, a node weight of the switch B is updated to 2, and a node weight of the switch D is updated to 9.

In some embodiments, after the Dijkstra algorithm calculates the shortest distance path between the objective switch and other nodes, the weight of other nodes is the total weight of the link included in the shortest distance path corresponding to other nodes.

In FIG. 5, if a device indicated by the objective address is a switch F, the objective path is a path formed by the switch A, the switch B, the switch D, and the switch F.

In block 405, the flow entries are generated based on the objective paths.

In some embodiments, the objective paths include an address of the data packet from the objective switch to the next switch, an address of the next switch can be added to the flow entries, and block 406 can be performed.

For example, in FIG. 5, the next switch in the objective path is the switch B, an address of the switch B can be added to the flow entries, the flow entries are transmitted to the switch A, the flow entries indicate that the switch A transmits the data packet to the switch B. The SDN controller 21 can also generate the flow entries in respect to each switch based on the objective path, and the flow entries can be transmitted to the corresponding switch.

In some embodiments, the SDN controller 21 can transmit a flow entry 1 to the switch B, the flow entry 1 indicates that the switch B transmits the data packet to the switch D. The SDN controller 21 can also send a flow entry 2 to the switch D, the flow entry 2 indicates the switch D transmits the data packet to the switch F.

In block 406, the flow entries are sent to the objective switch.

After the objective switch received the flow entries, the flow entries can be installed and the data packet can be forwarded according to the flow entries.

The electronic appliance architecture of the vehicle-mounted Ethernet 20 adopts the SDN controller 21 to control the switches, transmission of the data packet can be dynamically controlled. The SDN controller 21 obtains the weight of the links based on the performance information of the links, the objective paths can be determined. The path of the data packet can be adjusted based on the performance information of the links to ensure the data transmission performance of the objective paths, the data transmission efficiency is improved. The data packet can be adjusted to an idle path, the data packet transmission performance is improved.

The electronic appliance architecture of the vehicle-mounted Ethernet 20 adopts the TSSDN, the TSN can ensure the certainty and the low latency of the data transmission, the SDN can provide the dynamic control of the network traffic. The TSSDN enables a Vehicle Ethernet to effectively support a variety of different Vehicle applications and meet data transmission requirements of various Vehicle applications, the performance and reliability of the various applications can be ensured, and flexibility of vehicle configuration can be improved.

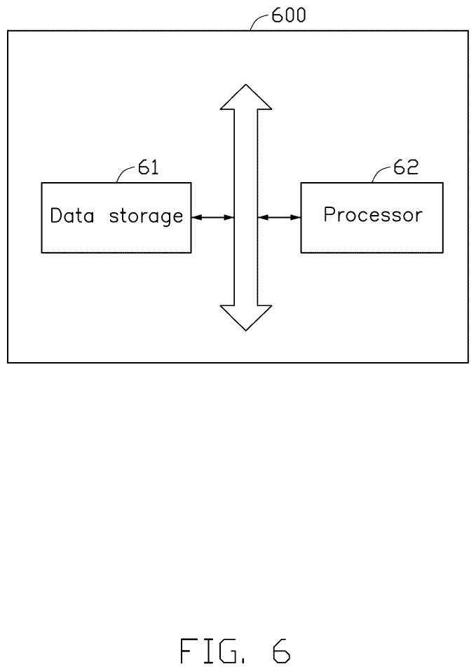

As shown in FIG. 6, one exemplary embodiment of an electronic device 600 comprises at least one processor 62 and a data storage 61. The data storage 61 stores one or more programs which can be executed by the at least one processor 62. The data storage 61 is used to store instructions, and the processor 62 is used to call up instructions from the data storage 61, so that the electronic device 600 performs the steps of the method in the above embodiment. The electronic devices 600 can be desktop computers, laptops, handheld computers, cloud servers and other computing devices. The electronic devices 600 can interact with users through keyboard, mouse, remote control, touchpad or voice control devices.

In one embodiment, a non-transitory storage medium recording instructions is disclosed. When the recorded computer instructions are executed by a processor of an electronic device 600, the electronic device 600 can perform the method.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A data transmission method applied to a Software Defined Network (SDN) controller, the SDN controller being configured in an electronic appliance architecture of a vehicle-mounted Ethernet, the electronic appliance architecture of the vehicle-mounted Ethernet comprising a plurality of switches, the plurality of switches communicating with the SDN controller, the method comprising:
obtaining performance information of a link between adjacent switches in the electronic appliance architecture of the vehicle-mounted Ethernet;
determining a weight of the link between the adjacent switches, based on the performance information of the link;
obtaining objective addresses of data packets;
determining objective paths of the data packets transmitted from an objective switch of the plurality of switches to the objective address, based on the weight of the link between the adjacent switches;
generating flow entries based on the objective paths, wherein the flow entries indicating the data packets are transmitted on the objective paths; and
sending the flow entries to the objective switch.

2. The data transmission method of claim 1, wherein the performance information of the link between the adjacent switches comprises a number of data packets sent from a first switch to a second switch over the link in the adjacent switches, the objective path is a path with a smallest total weight in one or more paths between the switch and the objective address, the total weight is a sum weight of the links in one path; determining the weight of the link between the adjacent switches, based on the performance information of the link comprises:
determining the weight of the link, based on the number of the data packets sent from the first switch to the second switch over the link in the adjacent switches, wherein the number of the data packets is positively correlated with the weight of the link.

3. The data transmission method of claim 1, wherein determining the objective paths of the data packets transmitted from the objective switch of the plurality of switches to the objective address, based on the weight of the link between the adjacent switches comprises:
determining the objective paths of the data packets, based on the weight of the link between the adjacent switches and a Dijkstra algorithm.

4. The data transmission method of claim 2, wherein determining the objective paths of the data packets transmitted from the objective switch of the plurality of switches to the objective address, based on the weight of the link between the adjacent switches comprises:
determining the objective paths of the data packets, based on the weight of the link between the adjacent switches and a Dijkstra algorithm.

5. The data transmission method of claim 1, wherein the electronic appliance architecture of the Vehicle-mounted Ethernet adopts a Time-Sensitive Software-Defined Network (TSSDN).

6. The data transmission method of claim 2, wherein the electronic appliance architecture of the Vehicle-mounted Ethernet adopts a Time-Sensitive Software-Defined Network (TSSDN).

7. An electronic appliance architecture of the Vehicle-mounted Ethernet, comprising:
a plurality of switches; and
a Software Defined Network (SDN) controller communicating with the plurality of switches, wherein the SDN controller is configured to:
obtain performance information of a link between adjacent switches in the electronic appliance architecture of the vehicle-mounted Ethernet;
determine a weight of the link between the adjacent switches, based on the performance information of the link;
determine objective addresses of data packets;
determine objective paths of the data packets transmitted from an objective switch of the plurality of switches to the objective address, based on the weight of the link between the adjacent switches;
generate flow entries based on the objective paths, wherein the flow entries indicating the data packets are transmitted on the objective paths;
send the flow entries to the objective switch; and
the objective switch is configured to receive the data packets and the flow entries, and forwards the data packets based on the flow entries.

8. The electronic appliance architecture of the vehicle-mounted Ethernet of claim 7, wherein the performance information of the link between the adjacent switches comprises a number of data packets sent from a first switch to a second switch over the link in the adjacent switches, the objective path is a path with a smallest total weight in one or more paths between the switch and the objective address, the total weight is a sum weight of the links in one path; the SDN controller determining the weight of the link between the adjacent switches, based on the performance information of the link comprises:
determining the weight of the link, based on the number of the data packets sent from the first switch to the second switch over the link in the adjacent switches, wherein the number of the data packets is positively correlated with the weight of the link.

9. The electronic appliance architecture of the vehicle-mounted Ethernet of claim 7, wherein the SDN controller determining the objective paths of the data packets transmitted from the objective switch of the plurality of switches to the objective address, based on the weight of the link between the adjacent switches comprises:
determining the objective paths of the data packets, based on the weight of the link between the adjacent switches and a Dijkstra algorithm.

10. The electronic appliance architecture of the vehicle-mounted Ethernet of claim 8, wherein the SDN controller determining the objective paths of the data packets transmitted from the objective switch of the plurality of switches to the objective address, based on the weight of the link between the adjacent switches comprises:
determining the objective paths of the data packets, based on the weight of the link between the adjacent switches and a Dijkstra algorithm.

11. The electronic appliance architecture of the vehicle-mounted Ethernet of claim 7, wherein the switch receives a type of the data packets, transmission priority of the data packets is determined based on the type of the data packets and a time-sensitive protocol, and the data packets are forwarded based on the transmission priority.

12. An electronic device, comprising:
at least one processor; and
a data storage storing one or more programs which when executed by the at least one processor, cause the at least one processor to:
obtain performance information of a link between adjacent switches in the electronic appliance architecture of the vehicle-mounted Ethernet;
determine a weight of the link between the adjacent switches, based on the performance information of the link;
obtain objective addresses of data packets;
determine objective paths of the data packets transmitted from an objective switch of the plurality of switches to the objective address, based on the weight of the link between the adjacent switches;
generate flow entries based on the objective paths, wherein the flow entries indicating the data packets are transmitted on the objective paths; and
send the flow entries to the objective switch.

13. The electronic device of claim 12, wherein the performance information of the link between the adjacent switches comprises a number of data packets sent from a first switch to a second switch over the link in the adjacent switches, the objective path is a path with a smallest total weight in one or more paths between the switch and the objective address, the total weight is a sum weight of the links in one path; the at least one processor determining the weight of the link between the adjacent switches, based on the performance information of the link comprises:
determining the weight of the link, based on the number of the data packets sent from the first switch to the second switch over the link in the adjacent switches, wherein the number of the data packets is positively correlated with the weight of the link.

14. The electronic device of claim 13, wherein the performance information of the link between the adjacent switches comprises a number of data packets sent from a first switch to a second switch over the link in the adjacent switches, the objective path is a path with a smallest total weight in one or more paths between the switch and the objective address, the total weight is a sum weight of the links in one path; the at least one processor determining the weight of the link between the adjacent switches, based on the performance information of the link comprises:
determining the weight of the link, based on the number of the data packets sent from the first switch to the second switch over the link in the adjacent switches, wherein the number of the data packets is positively correlated with the weight of the link.

15. The electronic device of claim 12, wherein the at least one processor determining the objective paths of the data packets transmitted from the objective switch of the plurality of switches to the objective address, based on the weight of the link between the adjacent switches comprises:
determining the objective paths of the data packets, based on the weight of the link between the adjacent switches and a Dijkstra algorithm.

16. The electronic device of claim 13, wherein the at least one processor determining the objective paths of the data packets transmitted from the objective switch of the plurality of switches to the objective address, based on the weight of the link between the adjacent switches comprises:
determining the objective paths of the data packets, based on the weight of the link between the adjacent switches and a Dijkstra algorithm.

17. The electronic device of claim 12, wherein the electronic appliance architecture of the Vehicle-mounted Ethernet adopts a Time-Sensitive Software-Defined Network (TSSDN).

18. The electronic device of claim 13, wherein the electronic appliance architecture of the Vehicle-mounted Ethernet adopts a Time-Sensitive Software-Defined Network (TSSDN).
